(19) United States
(12) Patent Application Publication
(10) Pub. No.: US 2022/0356398 A1
(43) Pub. Date: Nov. 10, 2022

(54) Composition and Method for Improving the Water Transport Characteristics of Hydrophobic Soils

(71) Applicants: Ethox Chemicals, LLC, Greenville, SC (US); Target Specialty Products, Sante Fe Springs, CA (US)

(72) Inventors: Charles F. Palmer, JR., Greenville, SC (US); James H. Turner, Wauchula, FL (US)

(21) Appl. No.: 17/726,744

(22) Filed: Apr. 22, 2022

Related U.S. Application Data
(60) Provisional application No. 63/178,030, filed on Apr. 22, 2021.

(51) Int. Cl. C09K 17/18; C09K 17/38; B09C 1/08

(52) U.S. Cl. CPC C09K 17/18; C09K 17/38; B09C 1/08

(57) ABSTRACT

Provided is a method and mixture for treating a hydrophobic surface. The mixture comprises a wetting agent comprising;

a compound of Formula I:

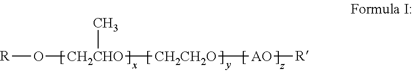

wherein:
R and R′ are independently selected from the group consisting of H, C₁₋₂₄ alkyl, aryl, C₁₋₂₄ alkylaryl, aryl(C₁₋₂₄)alkyl, —C(═O)—R¹, C(═O)—NHR¹, and C(═O)—O—R¹ wherein R¹ is selected from the group consisting of C₁₋₂₄ alkyl, aryl, C₁₋₂₄ alkylaryl, C₁₋₂₄ arylalkyl; A is an organic moiety derived from the group consisting of alkylene oxides having 4-12 carbon atoms and aryl epoxides having 8-12 carbon atoms; x=1-300; y=0-200; z=0-200; and
with the proviso that R and R′ cannot be H or ether functionality at the same time; and a compound of Formula II:

[R²O—(CH₂CH₂O)ₓ—(CH₂CH(CH₃)O)_{y}]_{z}—P(O)(OM)_{3-z} Formula II

where R² is C1-C24 alkyl, aryl, alkaryl; x=0-20; y=0-20; z=1 or 2 and M is H, Na, K, Ca, Mg or Li.

### CROSS-REFERENCE TO RELATED APPLICATIONS

This application claims the priority of pending U.S. Provisional Application No. 63/178,030 filed Apr. 22, 2021 which is incorporated herein by reference.

### FIELD OF THE INVENTION

The present invention is related to soil treatment polymers used to improve moisture transport of anionic organic phosphate esters in hydrophobic soils for improved moisture transport and moisture retention. Plant health is also improved, and dry spot is reduced, relative to known soil treatment polymers alone.

### BACKGROUND

The present invention is related to novel combinations of nonionic and anionic surfactants having desirable properties for improving the water transport characteristics of hydrophobic surfaces. This invention is generally related to the treatment of hydrophobic surfaces, hydrophobic substrates and more specifically the treatment of hydrophobic soils. The instant invention is directed to a new method for improving the water transport characteristics of hydrophobic surfaces and hydrophobic soils.

It is known that soil particles contain a large number of small channels or capillaries through which water is capable of flowing, and flow may be graded on the basis of the capillary or pore diameters. As water is made to flow through a channel, whether that channel be a soil pore or not, the rate of capillary water flow through the channel will be higher if the water is capable of wetting the channel surface. At the interface of the water and the capillary surface, however, there exists a long range van der Waal interaction between the water and the capillary surface. While the van der Waals interaction typically extends less than 200 angstroms into the body of water, it nonetheless decreases the ability of the water to wet the capillary surface, thereby increasing the contact angle between the water and the capillary surface and hindering the flow of water therethrough. While the negative effect of the van der Waals interaction may be negligible in the case of water flowing through a household pipe, when one considers the flow of water through minute soil pores, this interaction has a major effect.

Agronomists and farmers have to work with all types of plant growth media such as sand, natural earth, horticultural soils, and various soil-mimicking, soil-less plant culture substrates; however, the bane of essentially all agriculturalists is a hydrophobic/water repellent soil. Water repellent soil retards water infiltration into the soil matrix and often renders entire areas of the upper layers of the soil substrate essentially impervious to water penetration. Under rainfall or irrigation conditions, dire environmental consequences can result from the water repellency of the topsoil, such as surface runoff of water and aqueous compositions containing treatment materials, such as pesticides and fertilizers, into pristine areas and/or potable reservoirs. There are serious consequences resulting from aqueous pesticide flow through “fingers” that usually attend water repellent soil which can provide rapid transport of pesticide compositions to the local ground water table and thus increase the risk of ground water contamination.

The hydrophobicity/water repellency of a soil is not only a function of the initial water content of the soil but is also a function of soil particle size and the type of organic matter incorporated therein. For example, sands are more prone to water repellency than clays. Organic matter induces water repellency in the soils in many ways, such as by providing hydrophobic organic substances leached from the plant litter; organic substances that have been irreversibly dried; and microbial by-products.

Before water will evenly infiltrate into or percolate through a soil matrix, there must be a continuous film of water on the soil particles. In other words, the soil must first be wetted before water will flow. In addition, getting the soil evenly wetted is of paramount importance to the healthy growth of plants or seeds which are to be grown in the soil. Thus, agriculturalists will often apply various wetting agent surfactant compositions directly to the soil.

Although an increasing number of researchers are aware of the occurrence and consequences of water repellency in a wide range of soils, it is still a neglected field in soil science. (Dekker et al., International Turfgrass Society Research Journal, Volume 9, 2001, pages 498-505)

It has been recognized for years that in water repellent soil significant spatial variability can occur both in soil water content and degree of water repellency. Agriculturalists have attacked the soil water repellency problem through the use of wetting agent surfactant compositions. The degree of efficacy among chemistries and formulations has varied significantly. Often, the amount of surfactant required to ameliorate water repellency and/or to enhance infiltration, either perform variably or in an attempt to improve performance, higher rates of wetting agents are applied, such elevated rates often becoming injurious to plants.

Hydrophobic soils can cause problems on golf courses and other turf areas, in nurseries and greenhouses, and in open fields. Golf course managers commonly report problems with localized dry spots on their greens. These dry spots become a serious turf management problem during the summer months, especially during periods of drought. Despite frequent irrigation, the soil in these spots resists wetting, resulting in patches of dead or severely wilted turf. The water applied wets the turf but does not adequately penetrate the soil surface to reach the root zone.

Nursery operators sometimes encounter hard-to-wet media in pots and greenhouse beds. Farmers who work organic soils often complain that the soil wets too slowly, reducing crop productivity. Problems with hydrophobic soils are also commonly associated with citrus production areas, with locations where mine spoils have been deposited, and with burned-over forestland and grassland.

If water cannot readily penetrate and wet the soil, the availability of moisture to plants is reduced, decreasing the germination rate of seeds, the emergence of seedlings, and the survival and productivity of crop plants. Lack of sufficient water in the soil also reduces the availability of essential nutrients to plants, further limiting growth and productivity. In addition, water that cannot penetrate the soil runs off the surface and increases soil erosion. Water repellency often occurs in localized areas. As a result, the soil wets nonuniformly, and dry spots occur.

In hydrophobic soils, the soil particles are apparently coated with substances that repel water, much like wax. In studies of localized dry spots in turf grass, the soil particles were found to be coated with a complex organic, acidic material. Humic acid is often a component of this acidic material.

Nonionic surfactants, or surface active wetting agents, reduce the surface tension of water allowing the water molecules to spread out. When applied to water repellent soils in high concentrations, surfactants can improve the ability of water from rain or watering to penetrate the soil surface and thus increase the infiltration rate. However, most nonionic surfactants have significant water solubility and thus are rapidly removed by repeated rains or watering. In addition, most nonionic surfactants have one or more hydroxyl end groups that are easily oxidized or attacked by microbial agents, both of which reduce the durability of the treatment.

The prevention of dew formation on grass blades on managed grass and turf surfaces is also often desirable. The water drops present in dew provide needed moisture for the growth of fungal diseases of turf grasses. If the formation of dew is suppressed, the grass blades can dry out more quickly and thus the growth of fungal diseases can be minimized.

In dry periods, turf can be affected by drought stress. This can manifest itself in a number of ways, and in extreme cases the turf may die. Turf grass maintained on light soil, e.g. sand rootzone golf greens and links golf courses, is particularly prone to drought stress as is turf which is grown in generally poor soil conditions. Curiously, drought stress not only occurs in dry conditions, but also in relatively wet seasons due, for example, to rootbreaks, buried materials close to the surface, or through general inefficiency of an irrigation system.

Soils can also suffer drought stress. Thus, on heavy soils, one of the first signs of drought stress is that surface cracks appear on the soil. It will be appreciated that drought stress, in all its various forms, is undesirable and that it would be advantageous to avoid or reduce it.

So-called soil capping, i.e. crusting of the soil surface, can occur due to the pounding action of raindrops on soil. Capping can give rise to various problems, especially in seedbeds on light soils where it can prevent or reduce seedling emergence, thus resulting in a patchy, uneven sward. It would be desirable to be able to avoid soil capping, or at least reduce its effects.

Additionally, in many places water is becoming an ever decreasing resource, as is evidenced by dry rivers, low water tables and frequent restrictions on water usage. Further, in times of water shortage, it is often amenity users of water (e.g. golf courses etc.) where restrictions are enforced. It would, therefore be highly advantageous to be able to treat turf and soil so as generally to improve their water conservation so as to promote efficient use and minimize wastage.

It is also known that water conservation is a major issue in the United States and other countries, as water becomes an increasingly expensive commodity. Turf, particularly managed turf such as that located at golf courses, athletic fields, office parks and similar areas, uses large amounts of water. In past surveys by the Golf Course Superintendents Association of America (GCSAA), respondents indicated that irrigating an eighteen hole golf course in the U.S., having an average area of 77.7 irrigated acres, required an average of 28.5 million gallons of water each year. Of course the survey indicated regional differences in irrigation demand, with the Southwest US requiring 88 million gallons of water per year while the Mid-Atlantic states required 10 million gallons of water on average.

Among other problems faced in the areas of managed turf is localized dry spot caused by water-repellent soil conditions. Although this hydrophobic soil condition has several possible causes, researchers generally agree that the formation of an organic coating on the soil particles caused by the decomposition of plants and/or organisms causes the problem. The condition is characterized by irregular and isolated areas of problematic turf grass on the golf course, in the lawn or in other areas of turf.

The symptoms of localized dry spot are treated with surfactants, or surface-active agents. Some surfactants used to treat the condition are surfactant polymers. A surfactant polymer generally contains large segments or “blocks” of monomer which are hydrophobic in nature, attached to large blocks, which are hydrophilic in nature. Such surfactant polymers are generally referred to as “block copolymers” and give the polymer its surface-active nature. It is generally accepted that the hydrophobic portion of the surfactant molecule is attracted to the water repellent organic coating on the soil, whereas the hydrophilic portion of the surfactant remains readily accessible to water, thus allowing water to move into the soil profile, rather than running off of the surface.

A large number of surfactants are currently being marketed to manage localized dry spots. Such products are often marketed as soil wetters or wetting agents. Wetting agents are materials that increase the area that a droplet of a given volume of spray mixture will cover on a target. The management approach for using soil wetters and wetting agents generally involves direct application of the agents to the localized, problematic area, on an as needed basis, as part of an overall caring program.

U.S. Pat. Nos. 6,481,153 and 6,591,548 and 6,675,529, each of which is incorporated herein by reference, disclose soil additive formulations comprising humic acid redistribution, or removal, compounds and methods for reducing water repellency within sandy soils by the application of these formulations. The humic acid redistribution compounds contain substituted succinic acid salts, a polycarboxylic acid salt, and a material to reduce the surface tension of a humic acid waxy coating.

U.S. Pat. Nos. 6,857,225 and 6,948,276, each of which is incorporated herein by reference, describe a soil additive formulation for reducing water repellency comprising a multi-branched wetting agent having an “oxygen-containing polyfunctional base compound and at least three surfactant branches attached thereto, wherein each surfactant branch includes both hydrophilic and hydrophobic constituents.” The formulation also includes a secondary compound that actively lowers the surface tension of humic acid waxy coatings from hydrophobic sand particles. U.S. Pat. No. 6,857,225 describes a method for reducing localized dry spot formation by application of the additive formulation.

U.S. Pat. No. 9,487,698 B2 is directed to fatty acid ester-capped random and block copolymer wetting agents for treating sandy soils for long-term reduction of water repellency. Importantly, such capped wetting agents provide sustained moisture penetration over a sustained period of time since they have very low water solubility and thus are not easily rinsed off the treated surfaces. In addition, microbial decomposition is slowed due to the caps. Methods of treating sandy soils with such compounds and formulations thereof are also contemplated within this invention.

There has been a long-felt need for soil treatment compositions that combine both a humic acid removal product, to reduce a major cause of hydrophobic soils, with a long lasting soil particle treatment to allow increased wetting rates so that rain or irrigation water is able to quickly penetrate and infiltrate the water repellent soil. The use of these wetting agent compositions will result in a more effective wetting of the root zone during rain events and/or irrigation applications as well as improve the ability of the soil to hold water in the root zone, thereby inducing better plant growth and decreased water run-off. There is also an ongoing need for hydrophilic treatments for soils that are durable to repeated exposures to water and resist rapid oxidation and microbial attack. The treatment agent must also not harm plant life exposed to it.

In spite of the extensive efforts focused on improved soil wetting the art still lacks a suitable solution. More specifically, the art lacks a composition capable of improving the water retention capabilities of soil while also mitigating the effects of humic acid in and on the soil.

### SUMMARY OF THE INVENTION

It is a primary object of the present invention to provide a combination of nonionic surfactants useful for treating hydrophobic soils with ionic combinations of humic acid removal agents.

It is another object of the present invention to provide a method of promoting the transport of water through medium and coarse-grained soils by the use of economical quantities of a soil amendment.

It is a further object of the present invention to provide such a process where the soil amendment is also a composition characterized by a low washout rate from soil, thereby rendering the composition even more cost-effective.

It is also an object of the present invention to provide a method for improving the water transport characteristics of hydrophobic soils.

Still another object of the invention is to provide certain phosphorus and potassium derivatives that have plant nutrient value.

A further object of the invention is to provide certain random and block polypropylene oxide derivatives to enhance the infiltration of water and/or aqueous compositions through hydrophobic/water repellent soil.

It is a specific object of the present invention to provide certain hydrophobic, water insoluble polymers or blends thereof, to hydrophobic soil or turf to improve the ability of water to penetrate the soil surface and infiltrate the treated layers of soil.

A still further object of the invention is to provide a method of treating turf and soil to alleviate drought stress and soil cupping and to improve water conservation in soil.

These and other objects, as will be realized, are provided in a mixture for treating a hydrophobic surface comprising:

a wetting agent comprising;
a compound of Formula I:

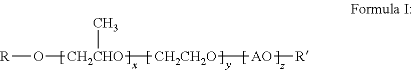

wherein:
R and R′ are independently selected from the group consisting of H, C₁₋₂₄ alkyl, aryl, C₁₋₂₄ alkylaryl, aryl(C₁₋₂₄)alkyl, —C(═O)—R¹, C(═O)—NHR¹, and C(═O)—O—R¹ wherein R¹ is selected from the group consisting of C₁₋₂₄ alkyl, aryl, C₁₋₂₄ alkylaryl, C₁₋₂₄ arylalkyl; A is an organic moiety derived from the group consisting of alkylene oxides having 4-12 carbon atoms and aryl epoxides having 8-12 carbon atoms; x=1-300; y=0-200; z=0-200; and
with the proviso that R and R′ cannot be H or ether functionality at the same time; and a compound of Formula II:

[R²O—(CH₂CH₂O)ₓ—(CH₂CH(CH₃)O)_{y}]_{z}—P(O)(OM)_{3-z} Formula II

where R² is C₁-C₂₄ alkyl, aryl, alkaryl; x=0-20; y=0-20; z=1 or 2 and M is H, Na, K, Ca, Mg or Li.

Yet another embodiment is provided in a method for treating a hydrophobic surface comprising:

forming a wetting agent comprising;
a compound of Formula I:

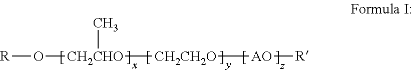

wherein:
R and R′ are independently selected from the group consisting of H, C₁₋₂₄ alkyl, aryl, C₁₋₂₄ alkylaryl, aryl(C₁₋₂₄)alkyl, —C(═O)—R¹, C(═O)—NHR¹, and C(═O)—O—R¹ wherein R¹ is selected from the group consisting of C₁₋₂₄ alkyl, aryl, C₁₋₂₄ alkylaryl, C₁₋₂₄ arylalkyl; A is an organic moiety derived from the group consisting of alkylene oxides having 4-12 carbon atoms and aryl epoxides having 8-12 carbon atoms; x=1-300; y=0-200; z=0-200; and with the proviso that R and R′ cannot be H or ether functionality at the same time; and a compound of Formula II:

[R²O—(CH₂CH₂O)ₓ—(CH₂CH(CH₃)O)_{y}]_{z}—P(O)(OM)_{3-z} Formula II

where R² is C₁-C₂₄ alkyl, aryl, alkaryl; x=0-20; y=0-20; z=1 or 2 and M is H, Na, K, Ca, Mg or Li. In a particularly preferred embodiment. A particularly preferred embodiment of Formula II R² is isodecyl, x=6, y=0, M=H, and z=1; and applying said wetting agent to said hydrophobic surface.

### DESCRIPTION

The present invention is also related to a mixture for, and method of, enhancing water retention of soils and providing plant nutrients thereto over an extended period of time using certain random and block polypropylene oxide derivatives and esters thereof along with certain phosphate esters. Furthermore, the present invention is generally related to the use of certain random and block polypropylene oxide derivatives to enhance the infiltration of water and/or aqueous compositions through hydrophobic/water repellent soil. More particularly, the present invention is related to the use of certain random and block polypropylene oxide derivatives to rapidly improve the hydrophilicity of such soil.

The invention is further related to a new method for improving the water transport characteristics of hydrophobic soils. The applicants have found that the application of certain hydrophobic, water insoluble polymers or blends thereof, to hydrophobic soil or turf will improve the ability of water to penetrate the soil surface and infiltrate the treated layers of soil.

This invention is also related to a method of treating turf and soil to alleviate drought stress and soil capping and to improve water conservation in soil. The instant invention further relates to a method of promoting the transport of water through medium and coarse-grained soils.

Soil treatment polymers are disclosed in US 2008/0172937 which is incorporated herein in its entirety. Organic phosphate esters have not been considered suitable for use in the treatment of hydrophobic soils. Soil treatment polymers are relatively non-polar organic materials with limited water solubility. In neutral form, where they are more likely to be compatible with the soil treatment polymers, the phosphate esters are fairly strong acids and may be phytotoxic and they are expected to burn the turf, or other plant materials, to which it was applied. When the phosphate esters are neutralized to minimize the phytotoxicity and increase the water solubility and improve the detergency, or ability to remove humic acid, they become salts and their polarity is greatly increased. This polarity increase directly reduces the compatibility of the phosphate ester with the non-polar soil treatment polymers and makes it difficult to combine them into a homogeneous single product. We have found that the monophosphate of POE (6) decyl alcohol has good compatibility with the soil treatment polymers and has good humic acid removal properties. When incorporated at relatively low levels in the formulation with a polymer defined herein as Formula I, it provides good detergency while not causing the formulation to be phytotoxic as otherwise expected.

The invention provides compounds having the general structure of Formula I:

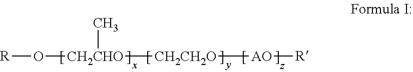

wherein R and R¹ are independently selected from the group consisting of H, C₁₋₂₄ alkyl, aryl, C₁₋₂₄ alkylaryl, aryl(C₄₋₂₄)alkyl, —C(═O)—R¹, C(═O)—NHR¹, and C(═O)—O—R¹ wherein R¹ is selected from the group consisting of C₁₋₂₄ alkyl, aryl, C₁₋₂₄ alkylaryl, C₄₋₂₄ arylalkyl; A is an organic moiety derived from the group consisting of alkylene oxides having 4-12 carbon atoms and aryl epoxides having 8-12 carbon atoms; x=1-300; y=0-200; z=0-200; and with the proviso that R and R′ cannot be H or ether functionality at the same time. The compounds of Formula I may be random or block copolymers.

In a preferred embodiment of Formula I, x=10-100; y=0-50; and z=0-50. In a more preferred embodiment x=10-30; y=0-10; and z=0-10. In a particularly preferably embodiment x=18-21; y=1-2; and z=0-50. In a particularly preferred embodiment of Formula I, x is 18-20 or about 19 on average; y is 1-3 or about 2 on average, and z=0.

Compounds of Formula I are combined with certain detergent phosphate esters to make a composition for treatment of hydrophobic soils with improved reduction of localized dry spot. Methods for reducing dry spot and improving plant health are also claimed.

The compounds of Formula I are useful for improving the water transport characteristics of hydrophobic surfaces.

More specifically, the present invention is related to a mixture of compounds of Formula I with a phosphate ester having the general structure of Formula II:

[R²O—(CH₂CH₂O)ₓ—(CH₂CH(CH₃)O)_{y}]_{z}—P(O)(OM)_{3-z} Formula II

where R² is C1-C24 alkyl, aryl, alkaryl; x=0-20; y=0-20; z=1 or 2 and M is H, Na, K, Ca, Mg or Li. In a particularly preferred embodiment. In a particularly preferred embodiment of Formula II R² is isodecyl, x=6, y=0, M=H, and z=1.

The invention is also directed to a method for improving the water penetration rate through hydrophobic surfaces, inhibiting the formation of dew on grass, other plant surfaces, or other hydrophobic surfaces by applying an effective amount of a mixture of compounds having the Formula I and Formula II as defined above.

The invention further provides a process for increasing the wetting rate of water repellent soil which comprises the steps of: (i) preparing an aqueous wetting agent composition comprising: (a) a compound of the Formula I and Formula II (b) a surfactant and (c) water; and (ii) intimately contacting the water repellent soil with an effective amount of the wetting agent composition.

The instant invention also provides a process for rapidly increasing the hydrophilicity and infiltration of water into water repellent soil matrices. The process consists of applying to the water repellent soil an effective amount of a wetting agent composition comprising a mixture of the Formula I and Formula II.

The invention also provides a method for improvement and prevention of dry spots on the grass surface of a golf course comprising applying an effective amount of a mixture of the Formula I and Formula II. An effective amount is that amount sufficient to improve the wetting rate of the hydrophobic soil. An effective amount is typically about 0.5 to about 20 ounces of wetting agent per 1000 ft² of surface. More preferably the effective amount is about 1 to about 10 ounces of wetting agent per 1000 ft² of surface. Even more preferably the effective amount is about 3 to about 7 ounces of wetting agent per 1000 ft² of surface. If the application is below the effective amount dark spots will occur. If the application is above the effective amount no additional benefits are observed and material is wasted which is undesirable.

The compositions of the invention unexpectedly exhibit significantly enhanced infiltration, or wetting, rates in water repellent soil over that previously achieved in the prior art.

The compounds of Formula I are prepared by alkoxylation of a polyoxypropylene oxide prepared by reacting a polyoxypropylene oxide, C₁-C₂₄ alkyl ether with the required amount of 1,2-propylene oxide in the presence of potassium hydroxide in water solution at a temperature between 100° C. and 130° C. and more preferably at about 120° C. After the initial reaction, the residual volatiles are removed by stirring under vacuum such as for 30 minutes at 120° C. If required, depending on the degree of ethoxylation one desires, ethylene oxide may be optionally added at about 140° C. and allowed to react completely. Residual volatiles would then again be removed by stirring under vacuum such as for 30 minutes at about 120° C. The temperature would then reduced to about 60° C. and phosphoric acid would be added and stirred for about 30 minutes. The resulting product is typically a viscous clear oil having a molecular weight (MW) in the range of approximately 1200-1800 typically with a hydroxyl number in the range of 40.0-48.0.

The clear oil above is then heated to a temperature between about 80° C. and about 90° C. and then a fatty acid is added in the presence of an acid esterification catalyst. The mixture is heated to about 180°-190° C. with a nitrogen sparge for about 35-40 hours with water distillate being removed. The product ester is then cooled to about 85°-90° C. and sodium carbonate would and stirred for about 1 hour. Subsequently, about 50% hydrogen peroxide is added and allowed to stir for about 1 hour. After heating to about 100°-110° C., vacuum is applied and water removed. The resulting mass is cooled to about 50°-60° C. and filtered to remove suspended solids. The product is a viscous clear liquid having the desired acid values, hydroxyl number and saponification value.

After the alkoxylation of the polyoxypropylene oxide, C₁-C₂₄ alkyl ether, described above, the alkoxylated alcohols formed as intermediate products are subjected to esterification. The carboxylic acid component used for this purpose would be selected from linear or branched saturated or unsaturated fatty acids having 1 to 24 carbon atoms. The fatty acid chain may also be substituted with hydroxyl groups.

Typical examples of the fatty acid esterifying agents include lauric acid, myristic acid, palmitic acid, palmitoleic acid, stearic acid, isostearic acid, oleic acid, linoleic acid, linolenic acid, ricinoleic acid, 12-hydroxystearic acid, arachidonic acid, gadoleic acid, behenic acid, dimeric fatty acids, dimeric acids of the above fatty acids and erucic acid. Oleic acid, stearic acid and isostearic acid and technical mixtures thereof are preferred.

As usual in oleochemistry, these acids may also be present in the form of the technical cuts obtained in the pressure hydrolysis of natural fats and oils, for example palm oil, palm kernel oil, coconut oil, olive oil, sunflower oil, rapeseed oil or beef tallow. Fatty acids containing 12 to 18 carbon atoms are preferred, those containing 16 to 18 carbon atoms being particularly preferred.

The esterification of the alkoxylated product derived from the alkoxylation of the polyoxypropylene oxide, C₁-C₂₄ alkyl ether, and formed as an intermediate product may also be carried out by known methods. Suitable acidic catalysts for this purpose include, for example, methanesulfonic acid, butanesulfonic acid, p-toluenesulfonic acid, naphthalenesulfonic acid, alkyl benzenesulfonic acid and/or sulfosuccinic acid.

In addition, it is advisable to carry out the esterification reaction at elevated temperatures, for example at temperatures of about 140° to 275° C. and preferably about 150° to 185° C. with continuous removal of water of reaction from the equilibrium. The quantity of fatty acid used should be selected so that there are 1.0 to 1.2 and preferably 1.0 to 1.1 moles of fatty acid for every mole of the polyoxypropylene oxide, C₁-C₂₄ alkyl ether alkoxylate. This ensures that the esterification of the hydroxyl groups is substantially quantitative. If desired, a residual content of free fatty acid in the end reaction product may be neutralized with alkali metal hydroxide solution.

The Formula II phosphate ester component can be prepared by the sequence of alkoxylation of a C8-C18 alcohol with 0-30 moles of ethylene oxide alone, or in combination with propylene oxide, followed by phosphation with either phosphorus pentoxide or polyphosphoric acid, followed by neutralization with a suitable alkaline material. The phosphate ester produced must have enough water solubility to perform as a detergent so that humic acid and other hydrophobic substances may be removed from soil particles. Most preferred is decyl alcohol ethoxylated with six moles of ethylene oxide, and phosphated with polyphosphoric acid

The polymers of Formula I and II may be combined in any desired ratio. In a particularly preferred embodiment the mixture comprises about 0.1 to about 10 parts of Formula I to 1 part of Formula II. More preferably the mixture comprises about 1 to about 4 parts of Formula I to 1 part of Formula II. Even more preferably the mixture comprises about 2 to about 2.5 parts of Formula I to 1 part of Formula II. A ratio of about 2.2 parts of Formula I to about 1.0 parts of Formula II is particularly exemplary for demonstration of the invention.

In another aspect, the invention is directed to a method for improving the water transport characteristics of hydrophobic surfaces and hydrophobic soils by applying to the surface or soil an effective water transport improving amount of a mixture of the Formula I with Formula II.

The emulsion of the polymer of Formula I may be conveniently applied to the hydrophobic surface or soil by any of a number of methods including dipping, spraying, or wiping the emulsion onto the surface to be treated. After drying to remove the water vehicle, a coating of the inventive polymer remains on the treated surface rendering it hydrophilic. The hydrophilic coating is durable to repeated rinsings with water.

A thin coating of the polymer of formula I on the hydrophobic surfaces or soils is adequate to render it hydrophilic. Application of larger amounts of the polymer of formula I to a hydrophobic surface to make a thicker coating will not necessarily improve its hydrophilicity.

Effective amounts of the inventive polymer coating or emulsion necessary for adequate wettability of the hydrophobic surface or soil will vary with the desired level of hydrophilicity and depth of coverage. Moisture movement through treated soils will be improved according to the depth of treatment. Accordingly, the amount of dilution of the polymer of Formula I with water and emulsifiers will best be determined by consideration of the depth of the root zone and the amount of diluted emulsion needed to percolate down to the desired depth. The concentration and volume of the emulsion of the inventive polymer may then be adjusted so that the volume of water and emulsion is sufficient to carry the polymer down to the desired depth to treat the soil particle surfaces.

In general, the polymers of Formula I have low water solubility and will separate when added to water. They must be emulsified into water for delivery to the hydrophobic soils to be treated via a water spray or other irrigation method. The polymers of Formula I may be emulsified in water with any of a number of emulsifiers. Emulsifiers may be chosen to give best stability of the polymer of Formula I in a concentrated form as well as in diluted form for application to hydrophobic surfaces or soils. Preferred emulsifiers include nonionic surfactants, and especially preferred are nonionic ethylene oxide/propylene oxide block copolymers. A surface tension reducing additive may optionally be added to ensure adequate wetting of the hydrophobic surface or soil. Emulsifiers for soil application should be chosen so as not to damage turf or plant life.

Polymers of Formula I can be diluted in water emulsion to no more than 2 wt % of the polymer of Formula I for application to soil or to hydrophobic surfaces. The diluted solution may be applied to soil at a rate sufficient to allow treatment of the soil surface to a depth to encompass the entire turf root zone.

The treated hydrophobic surface becomes rapidly wettable by water, and will cause the treated surface to wick water thereby causing water to rise vertically up a treated surface. In the case of soils, the ability of water to penetrate soils is greatly increased. Dew formation on treated surfaces such as grass is also prevented.

The instant invention specifically relates to the discovery that wetting agent compositions comprising combinations of compounds of the Formula I and Formula II, significantly and unexpectedly enhance water and aqueous composition transport or infiltration through the solid matrices of hydrophobic/water repellent soil, and better than the Formula I materials alone. Additionally, it has been found that these compositions are highly efficacious over a wide range of concentrations which is of critical importance in achieving maximum agronomic and/or hydrological benefit when the compositions are to be used in irrigation scenarios. The benefit is realized in the reduction in run-off and in the delivery of water-soluble fertilizers.

Additionally, the combined compounds of Formula I and Formula II of the invention are formulated as an additive for hydrophobic soil for treating sandy areas, soils, or areas including both sand and soil; such as lawns, greens, pastures, beaches, dry desert-like areas, and the like; for effective moisture penetration. The formulations of the invention are also used for reducing localized dry spot formation within lawns or greens by providing long-term wetting treatments comprising the application of a soil additive formulation to a target lawn or green, wherein said soil additive formulation comprises the compounds of Formula I as noted above. The application can be done in a single-application, in a split application spaced 7 to 10 days apart formulations, or in other frequencies as necessary.

The formulations containing the compounds of Formula I and Formula II and method of treating sandy areas with such formulations may thus be utilized for the provision of moisture penetration benefits in sandy areas alone. In such a manner, the sandy area, such as a beach, may be modified to permit water penetration therein, to prevent unsightly water pools, for example, after raining, or to dry desert-like areas in order to permit water penetration to sustain root systems of plant-life which would not grow otherwise.

The compounds of Formula I and Formula II exhibit an excellent ability to provide the necessary water adhesion to the otherwise hydrophobic surface of the water repellent soil via the hydrophobic groups of the surfactant itself and therefore provide the beneficial wetting characteristics and water transport properties, through the hydrophobic soil. Any adhered water droplets will be pulled into the sand and/or soil by further adhesion by other particles or through cohesion with other water droplets. The wetting agent effectively permits appreciable and necessary amounts of moisture to penetrate the topsoil for beneficial moisture supply to the subterranean roots on a consistent and continuous basis for a relatively long period of time.

The soil additive formulation may comprise a wetting agent consisting essentially of Formula I and Formula II or, in an embodiment, the wetting agent may comprise about 0.1-99% by weight compounds of Formula I and Formula II with additional wetting agents; more preferably the wetting agent comprises about 1-99% by weight Formula I and Formula II; even more preferably about 5-95% by weight Formula I and Formula II; more preferably about 10-90% by weight Formula I and Formula II, with the remainder a mix of other additives as noted below.

In order to best ensure initial penetration of the wetting agents within the target topsoil areas, it is preferable to include at least one secondary compound within the formulation for further lowering of the surface tension at the topsoil surface which is also compatible with the aforementioned wetting agent having Formula I. The lowering of the surface tension allows more rapid penetration of the wetter into the soil profile.

Such a secondary compound can be an alkoxylated, preferably ethoxylated alcohol surfactant, such as a branched or unbranched C₆-C₆₀ alcohol ethoxylate or alkoxylated, preferably ethoxylated C₈-C₄₀ fatty acid for utilization in combination with the aforementioned wetting agent of Formula I.

The alkoxylated secondary compounds may be branched or unbranched in configuration. Examples of preferred types of alcohol alkoxylates for this purpose include C₆-C₆₀ alkyl, or alkylaryl EO/PO surfactants, linear or branched, and secondary or primary hydroxyl in type, including mixtures of surfactants comprising from 1 to 95 wt % of at least one surfactant selected from polyalkylene oxide compounds having general Formula III, general Formula IV or general formula V wherein general Formula III is:

R³—O—(C₂H₄O)_{b}(C₃H₆O)_{c}—R³ Formula III

wherein b is 0 to 500; c is 0 to 500; and each R³ is independently H, or an alkyl group with 1 to 4 carbon atoms; wherein the polyalkylene oxide has a preferred molecular weight in the range of 300 to 51,000; and a second optional different surfactant comprising a compound of general Formula IV:

R⁴—O—(CH₂CH₂O)ₓ(CHR⁵CH₂O)_{y}R⁶ Formula IV

wherein x is from 1 to 50; y is 0-50; R⁴ is a branched or linear alkyl, alkenyl, aryl or an aryl group optionally having an alkyl group substituent, the alkyl group having up to 60 carbon atoms; R⁵ is selected from H and alkyl groups having from 1 to 2 carbon atoms; and R⁶ is selected from H and alkyl groups having from 1 to 30 carbon atoms. Suitable secondary surfactants also include carboxylic and dicarboxylic esters of the general Formula V:

R⁷COₐ(CH₂CH₂O)ₓ(CHR⁸CH₂O)_{y}CO_{b}R⁹ Formula V

wherein x is from 1 to 50; y is 1-50; a is from 1 to 2; b is from 1 to 2; R⁷ is an alkyl or alkenyl group having up to 60 carbons or an aryl group optionally having an alkyl group substituent, the alkyl group having up to 60 carbon atoms; R⁸ is selected from H and alkyl groups having from 1 to 2 carbon atoms; and R⁹ is selected from H and alkyl groups having from 1 to 30 carbon atoms.

Additional secondary compounds can also be silicone surfactants which are widely known by those skilled in the art to reduce surface tension.

The preferred surfactants/emulsifiers to be used in combination with the compounds of Formula I are selected from the group consisting of random EO-PO copolymers, block EO-PO copolymers, random EO-PO-EO copolymers, block EO-PO-EO copolymers, random PO-EO-PO copolymers, block PO-EO-PO copolymers, R¹⁰-EOₓ—PO_{y}— and R¹⁰—PO_{y}-EOₓ, R¹⁰—(CH₂CH₂O)ₓOH, R¹⁰—SO₃ ⁻M⁺, R¹⁰—(CH₂CH₂O)ₓOSO₃ ⁻M⁺, (R¹⁰O)ₓP(═O)O⁻M⁺, R¹⁰CO₂ ⁻M⁺, or R¹⁰OSO₃ ⁻M⁺, R¹¹R¹²R¹³R¹⁴N⁺X⁻ wherein each R¹⁰, R¹¹, R¹², R¹³ and R¹⁴ is independently C₁₋₂₄ alkyl, aryl, alkylaryl, (C₁-C₂₄)—(C═O)— and mixtures thereof wherein EO is polymerized ethylene oxide and PO is polymerized propylene oxide.

The compounds of Formula I can also prevent development of dry spots on the grass surface of a golf course and also improve and reduce already developed dry spots by sprinkling said compound along with a carrier on the grass surface of a golf course.

While not limited to theory, it is hypothesized that when a mixture comprising Formula I is sprinkled on water repellent soil, the oxygen atoms of the polyoxypropylene section of the polymer hydrogen bond with water molecules to accelerate permeation of water into the water repellent soil which is hypothesized is to prevent dry spots for a long duration of time.

### Example 1 Manufacture of Rewetting Agent

Polyoxypropylene oxide, monobutyl ether (MW 340), 4181 parts, and 71 parts of 45% potassium hydroxide in water solution were combined and heated to 120° C. After purging of oxygen and removal of water, 9900 parts of 1,2-propylene oxide was added and allowed to completely react. Residual volatiles were removed by stirring under vacuum for 30 minutes at 120° C. Ethylene oxide, 920 parts, was then added at 140° C. and allowed to react completely. Residual volatiles were again removed by stirring under vacuum for 30 minutes at 120° C. The temperature was reduced to 60° C. and 44 parts of phosphoric acid were added and stirred for 30 minutes. The product was a viscous clear oil of approximately 1200 MW (hydroxyl number 47.4).

This clear oil, 14830 parts, was heated to 80° C. and then 2740 parts of stearic acid and 27 parts of p-toluenesulfonic acid were added. The mixture was heated to 180°−190° C. with a nitrogen sparge for 37 hours with water distillate being removed. The product ester was cooled to 85°-90° C. and 88 parts of sodium carbonate was added and stirred for 1 hour. Nine parts of 50% hydrogen peroxide was added and allowed to stir for 1 hour. After heating to 100°-110° C., vacuum was applied and water was removed. The mass was cooled to 50°-60° C. and filtered to remove suspended solids. The product was a viscous clear liquid with an acid value of 0.9 mg KOH/g, hydroxyl number of 8.5 mg KOH/g, and a saponification value of 31.8 mg KOH/g.

### Example 2 Manufacture of Rewetting Agent

Another rewetting agent similar to the product of Example I was prepared by the same procedure of Example I with the exception of no addition of ethylene oxide. The product ester had an acid value of 10.49, hydroxyl value of 22.1, and saponification value of 80.5.

### Example 3

Another rewetting agent similar to the product of Example I was prepared by the same general procedure of Example I with the exception of starting with diethylene glycol, methyl ether followed by the co-addition of propylene oxide (68%) and ethylene oxide (32%) to make a mixed alkoxylate. The alkoxylate was then esterified with oleic acid. The product ester had an acid value of 1.4, and saponification value of 16. This is referred to herein as ERS 02707.

### Example 4 Formulation of Rewetting Agent

The rewetting agent of Example III and a phosphate ester of Formula II was formulated with a number of surfactants in order to make the combination emulsifiable in water for application to turf. A blend was prepared comprising:

| | |
|---|---|
| ERS 02707 of EXAMPLE 3 | 22.5 parts |
| Ethylene oxide/propylene oxide block | 32.5 parts |
| copolymer known as L-64 | |
| Ethylene oxide/propylene oxide block | 10 parts |
| copolymer known as L-62 | |
| Ethylene oxide/propylene oxide block | 10 parts |
| copolymer known as 25-R-2 | |
| Ethfac PD-6 acid phosphate of POE (6) | 10 parts |
| decyl alcohol | |
| Water | 15 parts |

The resulting blend was homogeneous and readily diluted further in water and is referred to herein as Ethox 5149.

The samples were applied to 4 ft×4 ft plots with an application every 28 days at 4-6 fluid ounces of wetting agent per 1000 ft² of turf. The inventive examples demonstrated improved performance over comparative examples with Example 4, referred to as Ethox 5149, being optimum. The test performed included LDS formation, turf quality, phytotoxicity, visual dew, soil moisture distribution, average soil moisture, soil moisture uniformity, ball roll distance and surface firmness.

In LDS formation the plots are visually rated biweekly for the formation of localized dry spots. Data is recorded as percentage of the plot affected by LDS.

Turf quality was determined by visual observation and rated biweekly for overall turf quality. Quality was rated on a 1-9 scale where 9 indicates an ideal, dense, dark gree uniform turf, 6 is acceptable and 1 is dead turf.

Phytotoxicity was based on digital images collected at 2, 7 and 14 days following monthly wetting agent treatments to evaluate dark green color index (DGCI) and assess phytotoxicity.

Visual dew was determined based on a twice weekly determination of the presence of dew. Dew was rated on a 1 to 9 scale where 9 indicated extremely heavy dew formation and 1 indicated no dew.

Soil moisture distribution determines a volumetric soil moisture which was evaluated every 14 days using a portable time domain reflectometry (TDR) unit. Sixteen measurements were taken in each plot using a 4×4 ft grid at 1.5 and 3.0 inch sampling depths. Soil moisture maps were generated for each sampling date. Each soil moisture map would have the plots grouped by treatment and depth so that the differences in moisture can be determined visually.

Average soil moisture was determined for each plot wherein the date and depth were recorded. The average soil moisture value was calculated from the 16 sub-samples within each plot.

Soil moisture uniformity was calculated as the standard deviation from the 25 sub-samples within each plot.

Ball roll distance was determined using a USGA Stimpmeter modified for small plots wherein three balls are rolled in opposite directions on each plot. The average of six ball roll distances was then corrected to a distance for a standard Stimpmeter.

Surface firmness was evaluated biweekly using a Clegg hammer. Surface firmness was evaluated by dropping a 0.5 kg hammer 3 times on each plot to calculate the average Gₘₐₓ value.

The invention has been described with reference to the preferred embodiments without limit thereto. One of skill in the art would realize additional embodiments and improvements which are not specifically stated but which are within the meets and bounds of the claims appended hereto.

1. A mixture for treating a hydrophobic surface comprising:
a wetting agent comprising;
a compound of Formula I: 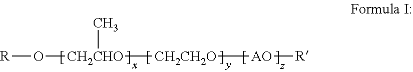
wherein:
R and R′ are independently selected from the group consisting of H, C₁-24 alkyl, aryl, C₁₋₂₄ alkylaryl, aryl(C₁₋₂₄)alkyl, —C(═O)—R¹, C(═O)—NHR¹, and C(═O)—O—R¹ wherein R¹ is selected from the group consisting of C₁₋₂₄ alkyl, aryl, C₁₋₂₄ alkylaryl, C₁₋₂₄ arylalkyl; A is an organic moiety derived from the group consisting of alkylene oxides having 4-12 carbon atoms and aryl epoxides having 8-12 carbon atoms; x=1-300; y=0-200; z=0-200; and
with the proviso that R and R′ cannot be H or ether functionality at the same time;
and a compound of Formula II:
[R²O—(CH₂CH₂O)ₓ—(CH₂CH(CH₃)O)_{y}]_{z}—P(O)(OM)_{3-z} Formula II
where R² is C1-C24 alkyl, aryl, alkaryl; x=0-20; y=0-20; z=1 or 2 and M is H, Na, K, Ca, Mg or Li.

2. The mixture for treating a hydrophobic surface of claim 1 wherein for Formula I, x=10-100, y=0-50 and z=0-50.

3. The mixture for treating a hydrophobic surface of claim 2 wherein for Formula I x=10-30, y=0-10 and z=0-10.

4. The mixture for treating a hydrophobic surface of claim 2 wherein for Formula I x=18-21, y=1-2, and z=0-50.

5. The mixture for treating a hydrophobic surface of claim 2 wherein for Formula I x is 18-20, y is 1-3 and z=0.

6. The mixture for treating a hydrophobic surface of claim 5 wherein for Formula I x is 19 on average and y is 2 on average.

7. The mixture for treating a hydrophobic surface of claim 1 wherein said compound of Formula I is a random copolymer or a block copolymer.

8. The mixture for treating a hydrophobic surface of claim 1 wherein said compound of Formula I is selected from the group consisting of random EO-PO copolymer, block EO-PO copolymer, random EO-PO-EO copolymer, block EO-PO-EO copolymer, random PO-EO-PO copolymer, block PO-EO-PO copolymer, R¹⁰-EOₓ—PO_{y}— and R¹⁰—PO_{y}-EOₓ, R¹⁰—(CH₂CH₂O)ₓOH, R¹⁰—SO₃ ⁻M⁺, R¹⁰—(CH₂CH₂O)ₓOSO₃ ⁻M⁺, (R¹⁰O)ₓP(═O)O⁻M⁺, R¹⁰CO₂ ⁻M⁺ and R¹⁰OSO₃ ⁻M⁺, R¹¹R¹²R¹³R¹⁴N⁺X⁻ wherein each R¹⁰, R¹¹, R¹², R¹³ and R¹⁴ is independently C₁₋₂₄ alkyl, aryl, alkylaryl, (C₁-C₂₄)—(C═O)— and mixtures thereof.

9. The mixture for treating a hydrophobic surface of claim 1 wherein said compound of Formula I has a molecular weight of 1200-1800.

10. The mixture for treating a hydrophobic surface of claim 1 wherein said compound of Formula I has a hydroxyl number of 40.0-48.0.

11. The mixture for treating a hydrophobic surface of claim 1 wherein said wetting agent comprises 0.1 to 10 parts of Formula I to 1 part of Formula II.

12. The mixture for treating a hydrophobic surface of claim 11 wherein said wetting agent comprises 1 to 4 parts of Formula I to 1 part of Formula II.

13. The mixture for treating a hydrophobic surface of claim 12 wherein said wetting agent comprises 2 to 2.5 parts of Formula I to 1 part of Formula II.

14. The mixture for treating a hydrophobic surface of claim 13 wherein said wetting agent comprises 2.2 parts of Formula I to 1.0 parts of Formula II.

15. The mixture for treating a hydrophobic surface of claim 11 wherein said wetting agent is an aqueous solution comprising no more than 2 wt % of said Formula II.

16. The mixture for treating a hydrophobic surface of claim 1 wherein for Formula II R² is isodecyl, x=6, y=0, M=H, and z=1.

17. The mixture for treating a hydrophobic surface of claim 1 wherein said wetting agent comprises 0.1-99 wt % Formula I and Formula II combined.

18. The mixture for treating a hydrophobic surface of claim 17 wherein said wetting agent comprises 1-99 wt % Formula I and Formula II combined.

19. The mixture for treating a hydrophobic surface of claim 18 wherein said wetting agent comprises 5-95 wt % Formula I and Formula II combined.

20. The mixture for treating a hydrophobic surface of claim 19 wherein said wetting agent comprises 10-90 wt % Formula I and Formula II combined.

21. The mixture for treating a hydrophobic surface of claim 1 wherein said wetting agent further comprising a compound defined by Formula III:
R³—O—(C₂H₄O)_{b}(C₃H₆O)_{c}—R³ Formula III
wherein:
b is 0 to 500;
c is 0 to 500; and
each R³ is independently H, or an alkyl group with 1 to 4 carbon atoms.

22. The mixture for treating a hydrophobic surface of claim 21 wherein said wetting agent comprises 1-95 wt % said Formula III.

23. The mixture for treating a hydrophobic surface of claim 21 wherein said compound defined by Formula III has a molecular weight of 300 to 51,000.

24. The mixture for treating a hydrophobic surface of claim 1 wherein said wetting agent further comprising a compound defined by Formula IV:
R⁴—O—(CH₂CH₂O)ₓ(CHR⁵CH₂O)_{y}R⁶ Formula IV
wherein:
x is from 1 to 50;
y is 0-50;
R⁴ is a branched or linear alkyl, alkenyl, aryl or an aryl group optionally having an alkyl group substituent, the alkyl group having up to 60 carbon atoms;
R⁵ is selected from H and alkyl groups having from 1 to 2 carbon atoms; and
R⁶ is selected from H and alkyl groups having from 1 to 30 carbon atoms.

25. The mixture for treating a hydrophobic surface of claim 24 wherein said wetting agent comprises 1-95 wt % said Formula IV.

26. The mixture for treating a hydrophobic surface of claim 1 wherein said wetting agent further comprising a compound defined by Formula V:
R⁷COₐ(CH₂CH₂O)ₓ(CHR⁸CH₂O)_{y}CO_{b}R⁹ Formula V
wherein:
x is from 1 to 50;
y is 1-50;
a is from 1 to 2;
b is from 1 to 2;
R⁷ is an alkyl or alkenyl group having up to 60 carbons or an aryl group optionally having an alkyl group substituent, the alkyl group having up to 60 carbon atoms;
R⁸ is selected from H and alkyl groups having from 1 to 2 carbon atoms; and
R⁹ is selected from H and alkyl groups having from 1 to 30 carbon atoms.

27. The mixture for treating a hydrophobic surface of claim 26 wherein said wetting agent comprises 1-95 wt % said Formula V.

28. The mixture for treating a hydrophobic surface of claim 1 further comprising a surfactant.

29. The mixture for treating a hydrophobic surface of claim 28 further wherein said surfactant is a silicone surfactant.

30. The mixture for treating a hydrophobic surface of claim 1 wherein said hydrophobic surface comprises soil.

31. The mixture for treating a hydrophobic surface of claim 1 further comprising water.

32. A method for treating a hydrophobic surface comprising:
forming a wetting agent comprising;
a compound of Formula I: 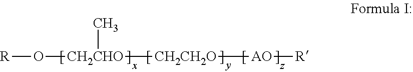
wherein:
R and R′ are independently selected from the group consisting of H, C₁₋₂₄ alkyl, aryl, C₁₋₂₄ alkylaryl, aryl(C₁₋₂₄)alkyl, —C(═O)—R¹, C(═O)—NHR¹, and C(═O)—O—R¹ wherein R¹ is selected from the group consisting of C₁₋₂₄ alkyl, aryl, C₁₋₂₄ alkylaryl, C₁₋₂₄ arylalkyl; A is an organic moiety derived from the group consisting of alkylene oxides having 4-12 carbon atoms and aryl epoxides having 8-12 carbon atoms; x=1-300; y=0-200; z=0-200; and
with the proviso that R and R′ cannot be H or ether functionality at the same time; and
and a compound of Formula II:
[R²O—(CH₂CH₂O)ₓ—(CH₂CH(CH₃)O)_{y}]_{z}—P(O)(OM)_{3-z} Formula II
where R² is C1-C24 alkyl, aryl, alkaryl; x=0-20; y=0-20; z=1 or 2 and M is H, Na, K, Ca, Mg or Li. In a particularly preferred embodiment. A particularly preferred embodiment of Formula II R² is isodecyl, x=6, y=0, M=H, and z=1; and
applying said wetting agent to said hydrophobic surface.

33. The method for treating a hydrophobic surface of claim 32 wherein said applying is selected from the group consisting of dipping, spraying and wiping.

34. The method for treating a hydrophobic surface of claim 32 wherein said applying is done in a single-application or in multiple applications.

35. The method for treating a hydrophobic surface of claim 34 wherein said multiple applications are 7 to 10 days apart.

36. The method for treating a hydrophobic surface of claim 32 wherein for Formula I, x=10-100, y=0-50 and z=0-50.

37. The method for treating a hydrophobic surface of claim 36 wherein for Formula I x=10-30, y=0-10 and z=0-10.

38. The method for treating a hydrophobic surface of claim 36 wherein for Formula I x=18-21, y=1-2, and z=0-50.

39. The method for treating a hydrophobic surface of claim 36 wherein for Formula I x is 18-20, y is 1-3 and z=0.

40. The method for treating a hydrophobic surface of claim 39 wherein for Formula I x is 19 on average and y is 2 on average.

41. The method for treating a hydrophobic surface of claim 32 wherein said compound of Formula I is a random copolymer or a block copolymer.

42. The method for treating a hydrophobic surface of claim 32 wherein said compound of Formula I is selected from the group consisting of random EO-PO copolymer, block EO-PO copolymer, random EO-PO-EO copolymer, block EO-PO-EO copolymer, random PO-EO-PO copolymer, block PO-EO-PO copolymer, R¹⁰-EOₓ—PO_{y}— and R¹⁰—PO_{y}-EOₓ, R¹⁰—(CH₂CH₂O)ₓOH, R¹⁰—SO₃ ⁻M⁺, R¹⁰—(CH₂CH₂O)ₓOSO₃ ⁻M⁺, (R¹⁰O)ₓP(═O)O⁻M⁺, R¹⁰CO₂ ⁻M⁺ and R¹⁰OSO₃ ⁻M⁺, R¹¹R¹²R¹³R¹⁴N⁺X⁻ wherein each R¹⁰, R¹¹, R¹², R¹³ and R¹⁴ is independently C₁₋₂₄ alkyl, aryl, alkylaryl, (C₁-C₂₄)—(C═O)— and mixtures thereof.

43. The method for treating a hydrophobic surface of claim 32 wherein said compound of Formula I has a molecular weight of 1200-1800.

44. The method for treating a hydrophobic surface of claim 32 wherein said compound of Formula I has a hydroxyl number of 40.0-48.0.

45. The method for treating a hydrophobic surface of claim 32 wherein said wetting agent comprises 0.1 to 10 parts of Formula I to 1 part of Formula II.

46. The method for treating a hydrophobic surface of claim 45 wherein said wetting agent comprises 1 to 4 parts of Formula I to 1 part of Formula II.

47. The method for treating a hydrophobic surface of claim 46 wherein said wetting agent comprises 2 to 2.5 parts of Formula I to 1 part of Formula II.

48. The method for treating a hydrophobic surface of claim 47 wherein said wetting agent comprises 2.2 parts of Formula I to 1.0 parts of Formula II.

49. The method for treating a hydrophobic surface of claim 32 wherein for Formula II R² is isodecyl, x=6, y=0, M=H, and z=1.

50. The method for treating a hydrophobic surface of claim 32 wherein said wetting agent is an aqueous solution comprising no more than 2 wt % of said Formula II.

51. The method for treating a hydrophobic surface of claim 32 wherein said wetting agent comprises 0.1-99 wt % Formula I and Formula II combined.

52. The method for treating a hydrophobic surface of claim 51 wherein said wetting agent comprises 1-99 wt % Formula I and Formula II combined.

53. The method for treating a hydrophobic surface of claim 52 wherein said wetting agent comprises 5-95 wt % Formula I and Formula II combined.

54. The method for treating a hydrophobic surface of claim 53 wherein said wetting agent comprises 10-90 wt % Formula I and Formula II combined.

55. The method for treating a hydrophobic surface of claim 32 wherein said wetting agent further comprising a compound defined by Formula III:
R³—O—(C₂H₄O)_{b}(C₃H₆O)_{c}—R³ Formula III
wherein:
b is 0 to 500;
c is 0 to 500; and
each R³ is independently H, or an alkyl group with 1 to 4 carbon atoms.

56. The method for treating a hydrophobic surface of claim 55 wherein said wetting agent comprises 1-95 wt % said Formula III.

57. The method for treating a hydrophobic surface of claim 55 wherein said compound defined by Formula III has a molecular weight of 300 to 51,000.

58. The method for treating a hydrophobic surface of claim 32 wherein said wetting agent further comprising a compound defined by Formula IV:
R⁴—O—(CH₂CH₂O)ₓ(CHR⁵CH₂O)_{y}R⁶ Formula IV
wherein:
x is from 1 to 50;
y is 0-50;
R⁴ is a branched or linear alkyl, alkenyl, aryl or an aryl group optionally having an alkyl group substituent, the alkyl group having up to 60 carbon atoms;
R⁵ is selected from H and alkyl groups having from 1 to 2 carbon atoms; and
R⁶ is selected from H and alkyl groups having from 1 to 30 carbon atoms.

59. The method for treating a hydrophobic surface of claim 58 wherein said wetting agent comprises 1-95 wt % said Formula IV.

60. The method for treating a hydrophobic surface of claim 32 wherein said wetting agent further comprising a compound defined by Formula V:
R⁷COₐ(CH₂CH₂O)ₓ(CHR⁸CH₂O)_{y}CO_{b}R⁹ Formula V
wherein:
x is from 1 to 50;
y is 1-50;
a is from 1 to 2;
b is from 1 to 2;
R⁷ is an alkyl or alkenyl group having up to 60 carbons or an aryl group optionally having an alkyl group substituent, the alkyl group having up to 60 carbon atoms;
R⁸ is selected from H and alkyl groups having from 1 to 2 carbon atoms; and
R⁹ is selected from H and alkyl groups having from 1 to 30 carbon atoms.

61. The method for treating a hydrophobic surface of claim 60 wherein said wetting agent comprises 1-95 wt % said Formula V.

62. The method for treating a hydrophobic surface of claim 32 further comprising a surfactant.

63. The method for treating a hydrophobic surface of claim 62 further wherein said surfactant is a silicone surfactant.

64. The method for treating a hydrophobic surface of claim 32 wherein said hydrophobic surface comprises soil.

65. The method for treating a hydrophobic surface of claim 32 further comprising water.
